(19) United States
(12) Patent Application Publication
(10) Pub. No.: US 2026/0067302 A1
(43) Pub. Date: Mar. 5, 2026

(54) INTRUSION DETECTION SYSTEM USING CRC IN VEHICLE NETWORK AND METHOD THEREOF

(71) Applicant: Foundation of Soongsil University-Industry Cooperation, Seoul (KR)

(72) Inventors: Seongsoo Lee, Seoul (KR); Hyungchul Im, Incheon (KR)

(73) Assignee: Foundation of Soongsil University-Industry Cooperation, Seoul (KR)

(21) Appl. No.: 19/314,052

(22) Filed: Aug. 29, 2025

(30) Foreign Application Priority Data
Aug. 30, 2024 (KR) 10-2024-0117601

(51) Int. Cl. H04L 9/40

(52) U.S. Cl. CPC H04L 63/1416

(57) ABSTRACT

An intrusion detection method performed by an intrusion detection system using CRC includes receiving in-vehicle CAN data in units of frame, generating first feature information by extracting a CAN ID from the in-vehicle CAN data in units of frame and performing zero padding, generating second feature information by extracting a CRC field from the in-vehicle CAN data in units of frame and performing the zero padding, training a learning model by setting the first feature information and the second feature information as input data and labeling, as output data, whether the CAN data is attack data or normal data, and detecting whether the CAN data is normal data or attack data by extracting a CAN ID and a CRC field from the received in-vehicle CAN data when training of the learning model is completed and inputting the CAN ID and the CRC field to the learning model.

### CROSS-REFERENCE TO RELATED APPLICATION

This application is based on and claims priority under 35 U.S.C. § 119 to Korean Patent Application No. 10-2024-0117601 filed on Aug. 30, 2024, in the Korean Intellectual Property Office, the disclosure of which is incorporated by reference herein in its entirety.

### BACKGROUND

### 1. Field

The present disclosure relates to an intrusion detection system and method using cyclic redundancy check (CRC) in a vehicle network, and more particularly, to an intrusion detection system and method using CRC having low computational complexity and high attack data detection performance.

### 2. Description of the Related Art

With the advancement of intelligence type connected vehicles and autonomous driving technology, electronic control units (ECUs) are increasingly used. ECUs, which have been used primarily for engine and drive control recently, are now main components for managing various vehicle systems, such as braking systems, transmissions, safety systems, and wireless communications. As new functions are continuously added to enhance safety, efficiency, and convenience, the role of ECU is more important. However, as the complexity of electronic systems included in vehicles increases, the risk of attackers that disrupt drive through various interfaces and threaten the safety of drivers and passengers is also increasing. In particular, a controller area network (CAN) protocol, which handles data transfer between ECUs, is vulnerable to attack due to inadequate security functions.

The CAN protocol broadcasts messages to all nodes in a network, but lacks a mutual authentication function between ECUs, and accordingly, the CAN protocol is vulnerable to security. Therefore, attackers may easily attack a CAN bus by accessing the CAN bus.

In particular, it has been proved that CAN frames were injected and controlled by directly accessing an OBD-II port while vehicles are in travel. A wireless access-based attack method using OBD-II was also introduced.

Based on this background, many researchers have conducted extensive research on intrusion detection systems (IDS), and extensive analyses, reviews, and experiments were performed.

Recently, machine learning-based methods have attracted attention in the intrusion detection field. A machine learning-based intrusion detection system utilizing CAN IDs and data payloads has been proposed, and basic algorithms, such as random trees and random forests, were used therefor. Furthermore, a deep convolutional neural network (IDS) using 29×29 images through 29 CAN IDs has also been proposed.

Most machine learning-based intrusion detection system (IDS) utilizes CAN IDs or data payloads as primary features, and there is no research that uses a CRC field of a CAN frame as a feature.

The technology underlying the present disclosure is disclosed in Korean Patent No. 10-1638613 (announced on Jul. 11, 2016).

### SUMMARY

The present disclosure provides an intrusion detection system and method using CRC in a vehicle network having low computational complexity and high attack data detection performance.

Additional aspects will be set forth in part in the description which follows and, in part, will be apparent from the description, or may be learned by practice of the presented embodiments of the disclosure.

According to an aspect, an intrusion detection method performed by an intrusion detection system using cyclic redundancy check (CRC) includes receiving in-vehicle controller area network (CAN) data in units of frame, generating first feature information by extracting a CAN ID from the in-vehicle CAN data in units of frame and performing zero padding, generating second feature information by extracting a CRC field from the in-vehicle CAN data in units of frame and performing the zero padding, training a learning model by setting the first feature information and the second feature information as input data and labeling, as output data, whether the CAN data is attack data or normal data, and detecting whether the CAN data is normal data or attack data by extracting a CAN ID and a CRC field from the received in-vehicle CAN data when training of the learning model is completed and inputting the CAN ID and the CRC field to the learning model.

The CAN ID may be composed of a maximum of 29 bits, and the CRC field may be composed of a maximum of 21 bits.

The generating of the first feature information may include receiving the CAN data in units of frame, extracting the CAN ID from the CAN data, and performing the zero padding to 29 bits when the CAN ID is less than 29 bits.

The generating of the second feature information may include extracting the CRC field from the CAN data received in units of frame and performing the zero padding to 21 bits when the CRC is less than 21 bits.

The learning model may be based on a recurrent neural network (RNN).

The learning model may be a long short-term memory (LSTM) neural network.

The training of the learning model may include inputting the first feature information composed of 29 bits and the second feature information composed of 21 bits, which are included in the same frame, to the LSTM neural network, and combining, through a concatenation layer, the first feature information and the second feature information that pass through the LSTM neural network, causing the combined information to pass through a fully connected (FC) layer, and training the LSTM neural network by labeling, as output data, whether the CAN data of a corresponding frame is attack data or normal data.

The CAN data may include a controller area network with flexible data rate (CAN-FD) data.

An intrusion detection system using cyclic redundancy check (CRC) includes an input unit configured to receive in-vehicle controller area network (CAN) data in units of frame, a controller configured to generate first feature information by extracting a CAN ID from the in-vehicle CAN data in units of frame and performing zero padding and configured to generate second feature information by extracting a CRC field from the in-vehicle CAN data in units of frame and performing the zero padding, a learning unit configured to train a learning model by setting the first feature information and the second feature information as input data and labeling, as output data, whether the CAN data is attack data or normal data, and a detector configured to detect whether the CAN data is normal data or attack data by extracting a CAN ID and a CRC field from the received in-vehicle CAN data when training of the learning model is completed and inputting the CAN ID and the CRC field to the learning model.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a diagram illustrating a structure of a controller area network (CAN) data frame, and FIG. 1B is a diagram illustrating a structure of a controller area network with flexible data rate (CAN-FD) data frame;

FIG. 2 is a configuration diagram of an intrusion detection system using cyclic redundancy check (CRC) according to an embodiment of the present disclosure;

FIG. 3 is a diagram illustrating a long short-term memory (LSTM) neural network;

FIG. 4 is a flowchart of an intrusion detection method using CRC according to an embodiment of the present disclosure;

FIG. 5 is a diagram specifically illustrating step S440 of FIG. 4; and

FIG. 6 is a diagram illustrating a result of comparing attack data detection performance of an intrusion detection system using CRC according to an embodiment of the present disclosure with other learning models.

### DETAILED DESCRIPTION

Hereinafter, embodiments of the present disclosure will be described in detail with reference to the attached drawings such that those skilled in the art may easily practice the disclosure. However, the present disclosure may be implemented in various different forms and is not limited to the embodiments described herein. In addition, for the purpose of clearly describing the present disclosure, parts irrelevant to the description are omitted in the drawings, and similar parts are designated with similar reference numerals throughout the specification.

Throughout the specification, when a part is said to be “connected” to another part, this includes not only a case where the part is “directly connected,” but also a case where the part is “electrically connected” with another element intervening therebetween. Furthermore, when a part is said to “include” a component, this does not exclude other components, but rather includes other components, unless otherwise specified.

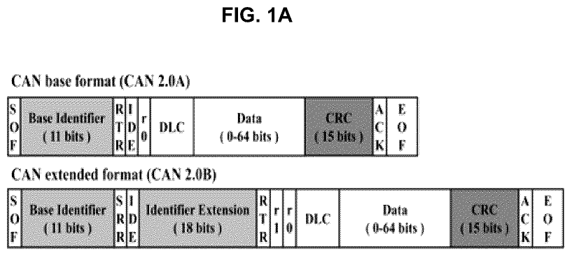

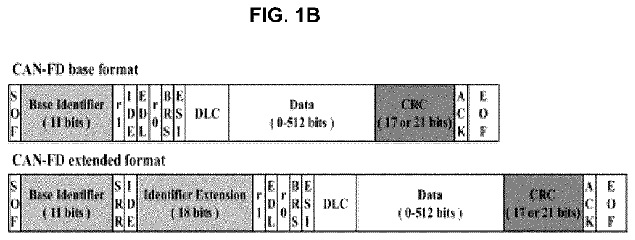

First, a controller area network (CAN) data frame and a controller area network with flexible data rate (CAN-FD) data frame are described with reference to FIGS. 1A and 1B.

FIG. 1A illustrates a structure of a CAN data frame, and FIG. 1B illustrates a structure of a CAN-FD data frame.

First, a CAN protocol enables all nodes connected to a CAN bus to transmit messages by using a multi-master bus method by which messages are broadcast to all CAN networks. A CAN supports data transfer rates of up to 1 Mbps, and all messages are transmitted and received based on synchronized time. Furthermore, a CAN uses a differential signaling method including CAN High and CAN Low through two twisted pair wires, and thus, the CAN is highly resistant to noise and external interference.

As illustrated in FIG. 1A, a CAN supports both a base format (CAN 2.0A) and an extended format (CAN 2.0B).

Each CAN frame is identified by a unique CAN ID which may have 11 or 29 bits long. The CAN ID is used to determine the message priority, and the lowest value has the highest priority.

A data length code (DLC) specifies the number of bytes in a data field, and the data field may include up to eight bytes. A CAN also includes a cyclic redundancy check (CRC) field to detect an error that may occur during communication.

Meanwhile, with technological advancement, the number of electronic control units (ECUs) having various functions in a vehicle has increased, and accordingly, a vehicle network demands a faster communication speed and greater data capacity. In order to meet the demand, BOSCH developed, in 2012, a CAN-FD which is a new protocol designed to overcome limitations of CAN.

The CAN-FD supports a communication speed of up to 8 Mbps and data payload of up to 64 bytes, and accordingly, much more data may be transmitted faster than a conventional CAN. Through this, the CAN-FD provides a solution that may effectively overcome the limitation of a conventional CAN protocol. Furthermore, the CAN-FD maintains compatibility with a CAN by being designed based on a CAN protocol.

As illustrated in FIG. 1B, the CAN-FD provides a new function through additional bits, such as an extended data length (EDL), bit rate switching (BRS), and an error status indicator (ESI).

When an EDL bit is recessive, a frame is defined as a CAN-FD frame, and when the EDL bit is dominant, the frame is defined as a CAN frame. When a BRS bit is recessive, a bit transfer rate is switched from a data phase. The ESI bit is used to identify an error state of a CAN-FD node.

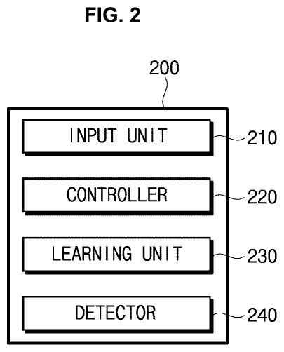

Hereinafter, an intrusion detection system using CRC according to an embodiment of the present disclosure is described with reference to FIG. 2.

FIG. 2 is a block diagram of an intrusion detection system using CRC according to an embodiment of the present disclosure.

As illustrated in FIG. 2, an intrusion detection system 200 using CRC according to an embodiment of the present disclosure includes an input unit 210, a controller 220, a learning unit 230, and a detector 240.

First, the input unit 210 receives in-vehicle CAN data in units of frame.

Here, the CAN data includes not only the CAN frame illustrated in FIG. 1A but also the CAN-FD frame illustrated in FIG. 1B.

Next, the controller 220 extracts a CAN ID from the in-vehicle CAN data in units of frame, performs zero padding to generate first feature information, extracts a CRC field from the in-vehicle CAN data in units of frame, and performs zero padding to generate second feature information.

Furthermore, the learning unit 230 sets the first and second feature information as input data, and labels output data indicating whether the corresponding CAN data is attack data or normal data to train a learning model.

Finally, when the learning model is completely trained, the detector 240 extracts a CAN ID and a CRC field from the received vehicle CAN data and inputs the vehicle CAN data to a learning model to detect whether the CAN data is normal data or attack data.

Meanwhile, the learning model according to an embodiment of the present disclosure is a learning model based on a recurrent neural network (RNN) and may be implemented as a long short-term memory (hereinafter, referred to as “LSTM”).

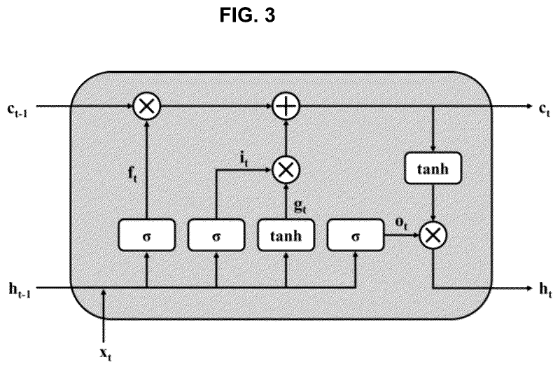

Hereinafter, an LSTM neural network is described below in more detail with reference to FIG. 3.

FIG. 3 is a diagram illustrating an LSTM neural network.

A basic recurrent neural network (RNN) includes a single recurrent layer, which may cause a gradient vanishing problem when processing long sequence data, and LSTM was designed to solve this issue.

As illustrated in FIG. 3, the LSTM includes a complex recurrent module having four interacting layers to process more efficient information. A core function of the LSTM controls a cell state through a special structure called a gate. A structure illustrated in FIG. 3 includes a forget gate, an input gate, and an output gate, and these gates control the flow of information to retain necessary information or remove unnecessary information. The respective gates determine which information is added to or removed from the cell state by using an activation function.

For example, the forget gate determines which information is removed from the cell state, and the input gate determines how new input information is integrated with the cell state. The output gate determines which information is passed to the next hidden state and generates an output.

As illustrated in FIG. 3, the forget gate, the input gate, and the output gate are denoted respectively as ft, it, and ot. Here, ct represents a cell state, gt represents a value used to update the cell state, and ht represents a hidden state. Finally, xt represents the external data input to an LSTM cell.

Through this gate mechanism, LSTM may selectively store necessary information and may effectively process long-term dependency even in long term sequence data. Therefore, LSTM has superior long-term memory capacity compared to a basic RNN and is widely used in complex sequence modeling tasks.

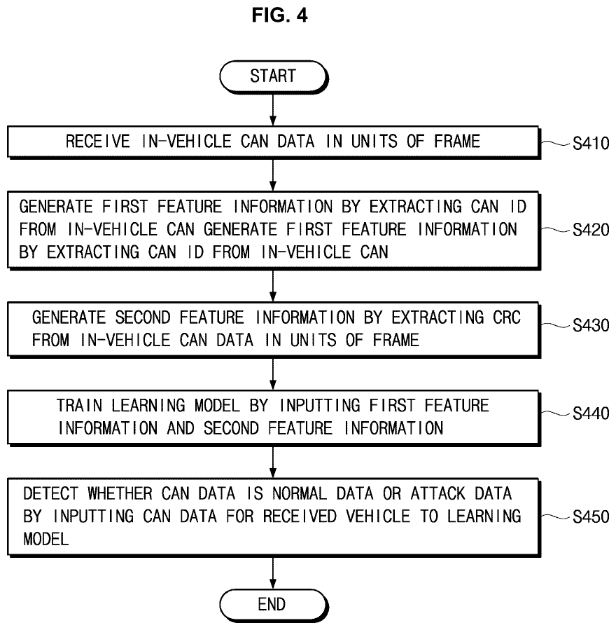

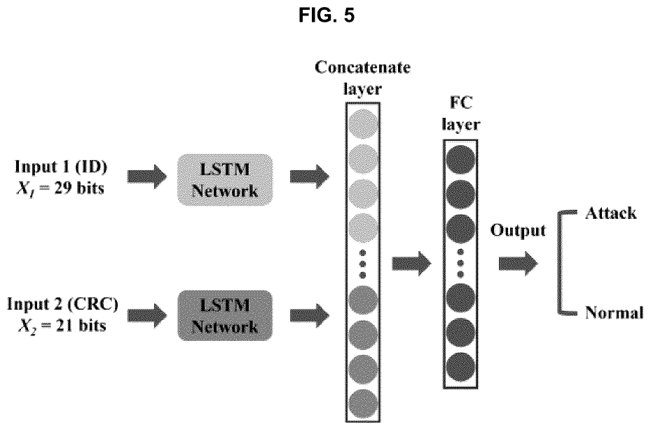

Hereinafter, an intrusion detection method using CRC according to an embodiment of the present disclosure will be described with reference to FIGS. 4 and 5.

FIG. 4 is a flowchart of an intrusion detection method using CRC according to an embodiment of the present disclosure.

First, the input unit 210 receives in-vehicle CAN data in units of frame (S410).

As described above, the input unit 210 receives CAN data having a CAN frame structure illustrated in FIG. 1A as well as CAN data having a CAN-FD frame structure illustrated in FIG. 1B.

Next, the controller 220 extracts a CAN ID from the in-vehicle CAN data in units of frame and generates first feature information by performing zero padding (S420).

Furthermore, the controller 220 extracts a CRC field from the in-vehicle CAN data in units of frame and generates second feature information by performing zero padding (S430).

The intrusion detection system 200 according to an embodiment of the present disclosure uses a CAN ID and a CRC field as main feature information, which are respectively referred to as first feature information X₁ and second feature information X₂.

First, the first feature information X₁ indicates the number of bits in the CAN ID, that is, an arbitration field. In the CAN, the arbitration field may be composed of 11 or 29 bits, and the same applies to CAN-FD. Therefore, X₁ includes a maximum of 29 bits, and when X₁ is less than 29 bits, the controller 220 performs zero padding in which the other bits are filled with 0.

The second feature information X₂ indicates the number of bits in the CRC field. In a CAN protocol, a CRC field is calculated by including a start frame (SoF), an arbitration field, a control field, and a data payload.

In particular, the CRC field inherently includes various types of information in the CAN frame, such as a CAN ID, a bit length, a CAN data payload.

A CAN standard protocol uses CRC 15, a CRC field is composed of 15 bits, and a polynomial for CRC-15 is as follows:

$${G}_{15} ( x ) = {x}^{15} + {x}^{14} + {x}^{10} + {x}^{8} + {x}^{7} + {x}^{4} + {x}^{3} + 1 \qquad Equation 1$$

In contrast to this, in CAN-FD, a CRC length is determined according to a size of the data payload. For example, when a data payload is less than 16 bytes, CRC-17 is used, and when the data payload is greater than 16 bytes, CRC-21 is used to enable the CRC field to be expanded up to 21 bits. Polynomials for CRC-17 and CRC-21 are given in Equation 2 and Equation 3.

$${G}_{17} ( x ) = {x}^{17} + {x}^{16} + {x}^{14} + {x}^{13} + {x}^{11} + {x}^{6} + {x}^{4} + {x}^{3} + x + 1 \qquad Equation 2$$

$${G}_{21} ( x ) = {x}^{21} + {x}^{20} + {x}^{13} + {x}^{11} + {x}^{7} + {x}^{4} + {x}^{3} + 1 \qquad Equation 3$$

Accordingly, when a CRC field of the second feature information X2 is less than 21 bits as in the first feature information X1, the controller 220 performs a preprocessing operation to adjust the other bits to 21 bits by applying zero padding by which the other bits are filled with 0.

Next, the learning unit 230 sets the first feature information X1 and the second feature information X2 as input data, labels as output data whether the corresponding CAN data is attack data or normal data, and trains a learning model (S440).

This may be represented as a mapping function, as shown in Equation 4 below.

$$Y = f ( {X}_{1} , {X}_{2} ) \qquad Equation 4$$

The first feature information X₁ is a sequence of X_{1,1}, X_{1,2}, X_{1,3}, . . . , X_{1,i}, and the second feature information X₂ is defined as X_{2,1}, X_{2,2}, X_{2,3}, . . . , X_{2,i}), where i represents the total number of CAN frames. X_{1,j} is represented by

$${x}_{1 , j}^{1} , {x}_{1 , j}^{2} , {x}_{1 , j}^{3} , … , {x}_{1 , j}^{n} ,$$

and X_{2,j} is also represented by

$${x}_{2 , j}^{1} , {x}_{2 , j}^{2} , {x}_{2 , j}^{3} , … , {x}_{2 , j}^{m} .$$

Here, j represents a frame index from 1 to i.

Also, n and m respectively represent fixed lengths of tuples in X_{1,j} and X_{2,j}.

n is fixed to 29 to match a 29-bit structure of the CAN ID, and m is set to 21 to match the 21-bit limit of a CRC field.

Finally, an output variable Y is determined by labels (y₁, y₂, y₃, . . . , yᵢ), and each label is numerically assigned based on a state of a CAN frame, wherein the normal data is represented as 0 and the attack data is represented as 1.

Hereinafter, an operation of a learning model according to an embodiment of the present disclosure is described with reference to FIG. 5.

FIG. 5 is a diagram specifically illustrating step S440 of FIG. 4.

As illustrated in FIG. 5, a structure of a learning model according to an embodiment of the present disclosure includes an LSTM layer that extracts information from a CAN ID and a CRC field, a concatenation layer that combines pieces of the extracted information, and an FC layer.

First, the first feature information X₁ and the second feature information X₂ extracted through a preprocessing process are subjected to LSTM operations as illustrated in FIG. 5. In an embodiment of the present disclosure, the data input to an LSTM model is configured in a three-dimensional form and uses a single time step, and an input dimension is set to 29 bits for the first feature information X₁ and set to 21 bits for the second feature information X₂.

The inputs are composed of values of 0 or 1.

The number of units in an LSTM layer directly affects the amount and complexity of information by which a model may be trained. The more the units, the more information and complex patterns may be learned, but requirements of computational resource also increase.

Therefore, according to an embodiment of the present disclosure, in order to design a lightweight intrusion detection system suitable for resource-constrained vehicle environments, the number of units in each LSTM layer is limited to 64. This setting reduces the total number of floating point operations (FLOPs) of the LSTM, which is calculated by Equation 5 below:

$${FLOPs}_{LSTM} = {U}_{l} \times ( {U}_{l} + {I}_{l} ) \times N \times 4 \qquad Equation 5$$

Here, UI represents the number of units, II represents an input dimension, and N represents a time step. Here, the reason for multiplying by 4 is that the LSTM includes three gates (a forget gate, an input gate, and an output gate) and one memory cell.

In addition, when two input sequences X₁∈ [symbol] ^{1×29} and X₂∈ [symbol] ^{1×21} are given, a learning model is calculated by Equation 6 below.

$${H}_{l}^{1} = {LSTM}_{l}^{1} ( {X}_{1} ) , {H}_{1} ∈ {64}^{} , \qquad Equation 6$$

$${H}_{l}^{2} = {LSTM}_{l}^{2} ( {X}_{2} ) , {H}_{2} ∈ {64}^{} ,$$

$${H}_{c} = Concat ( {H}_{1} , {H}_{2} ) , {H}_{c} ∈ {128}^{} ,$$

$${H}_{d} = {Dense}_{1} ( {H}_{c} ) , {H}_{d} ∈ {64}^{} ,$$

$$Y = σ ( {Dense}_{2} ( {H}_{d} ) ) , Y ∈ [ 0 , 1 ]$$

Here, σ represents a sigmoid activation function.

As illustrated in FIG. 5, the first LSTM and the second LSTM process the first feature information X₁ and the second feature information X₂ which are input data, and a concatenate layer combines the results into a single vector Hc. The vector Hc is transferred to an FC layer to obtain a new dimensional feature space, and finally, a Y output is processed by a Dense2 layer to be generated as a sigmoid activation function.

Once training of the learning model is completed, the detector 240 extracts the CAN ID and CRC field from the input CAN data for a vehicle and inputs the extracted CAN ID and CRC field to the learning model to detect whether the CAN data is normal or attack data (S450).

A process of extracting the CAN ID and CRC field from the CAN data for a vehicle and inputting the CAN ID and CRC field to a learning model is substantially the same as step S410 to step S440, and accordingly, detailed descriptions thereof are omitted.

Table 1 below shows a result of comparing the computational complexity of an intrusion detection system CRC-IDS using CRC according to an embodiment of the present disclosure with other learning models DCNN, LSTM-IDS, and HyDL-IDS.

TABLE 1

| | | | FLOPs |
|---|---|---|---|
| Models | Input Features | FLOPs | (CAN-FD) |
| DCNN [11] | ID Sequence | 100.13M | 100.13M |
| LSTM-IDS [12] | ID & DLC & Payload | 1.07M | 1.18M |
| HyDL-IDS [13] | ID & DLC & Payload | 0.13M | 1.68M |
| CRC-IDS | ID & CRC | 53,824 | 53,824 |

Other learning models DCNN, LSTM-IDS, and HyDL-IDS and the learning model CRC-IDS according to an embodiment of the present disclosure have different input data, and in this case, FLOPs are calculated by using Equation 5, and accordingly, it may be seen that, according to an embodiment of the present disclosure, both CAN data and CAN-FD are significantly smaller.

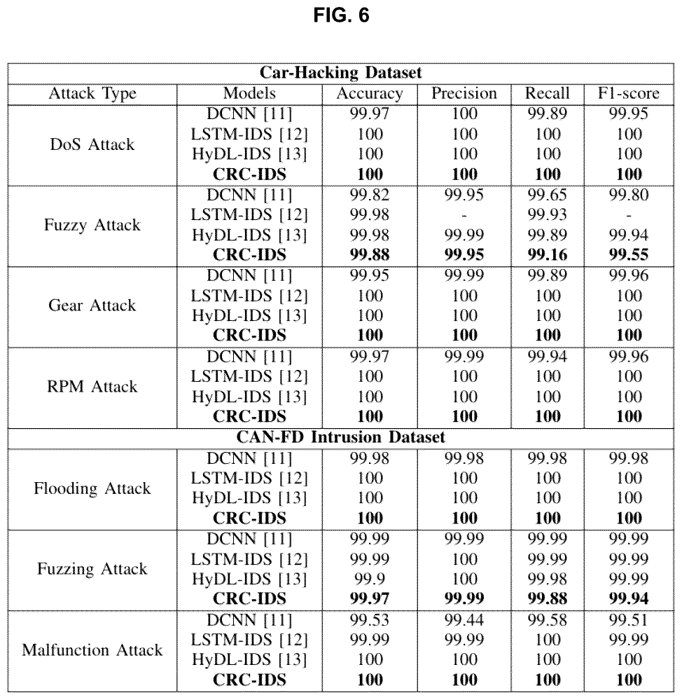

FIG. 6 is a diagram showing a result of comparing the attack data detection performance of an intrusion detection system using CRC according to an embodiment of the present disclosure with other learning models.

As illustrated in FIG. 6, it may be seen that the intrusion detection system CRC-IDS using CRC according to an embodiment of the present disclosure has superior detection performance for both CAN data and CAN-FD data with respect to attack data compared to other learning models such as DCNN, LSTM-IDS, and HyDL-IDS.

That is, it is experimentally checked that the intrusion detection system CRC-IDS using CRC according to an embodiment of the present disclosure has excellent accuracy, precision, recall, and F1-score of detection performance against DoS attack, Fuzzy attack, Gear attack, and RPM attack compared to other learning models.

As described above, according to an embodiment of the present disclosure, by extracting a CAN ID sequence and a CRC field as feature information and applying the CAN ID sequence and a CRC field to a learning model, computational complexity may be greatly reduced, and attack data may be detected more accurately.

Although the present disclosure is described with reference to the embodiments illustrated in the drawings, these are merely examples, and those skilled in the art will appreciate that various modifications and equivalent alternative embodiments are possible. Therefore, the true scope of protection of the present disclosure should be defined by the technical idea of the appended claims.

What is claimed is:

1. An intrusion detection method performed by an intrusion detection system using cyclic redundancy check (CRC), the intrusion detection method comprising:
receiving in-vehicle controller area network (CAN) data in units of frame;
generating first feature information by extracting a CAN ID from the in-vehicle CAN data in units of frame and performing zero padding;
generating second feature information by extracting a CRC field from the in-vehicle CAN data in units of frame and performing the zero padding;
training a learning model by setting the first feature information and the second feature information as input data and labeling, as output data, whether the CAN data is attack data or normal data; and
detecting whether the CAN data is normal data or attack data by extracting a CAN ID and a CRC field from the received in-vehicle CAN data when training of the learning model is completed and inputting the CAN ID and the CRC field to the learning model.

2. The intrusion detection method of claim 1, wherein
the CAN ID is composed of a maximum of 29 bits, and
the CRC field is composed of a maximum of 21 bits.

3. The intrusion detection method of claim 2, wherein
the generating of the first feature information includes receiving the CAN data in units of frame, extracting the CAN ID from the CAN data, and performing the zero padding to 29 bits when the CAN ID is less than 29 bits.

4. The intrusion detection method of claim 3, wherein
the generating of the second feature information includes extracting the CRC field from the CAN data received in units of frame and performing the zero padding to 21 bits when the CRC is less than 21 bits.

5. The intrusion detection method of claim 1, wherein
the learning model is based on a recurrent neural network (RNN).

6. The intrusion detection method of claim 5, wherein
the learning model is a long short-term memory (LSTM) neural network.

7. The intrusion detection method of claim 6, wherein the training of the learning model includes:
inputting the first feature information composed of 29 bits and the second feature information composed of 21 bits, which are included in the same frame, to the LSTM neural network;
combining, through a concatenation layer, the first feature information and the second feature information that pass through the LSTM neural network;
causing the combined information to pass through a fully connected (FC) layer; and
training the LSTM neural network by labeling, as output data, whether the CAN data of a corresponding frame is attack data or normal data.

8. The intrusion detection method of claim 1, wherein
the CAN data includes a controller area network with flexible data rate (CAN-FD) data.

9. An intrusion detection system using cyclic redundancy check (CRC), comprising:
an input unit configured to receive in-vehicle controller area network (CAN) data in units of frame;
a controller configured to generate first feature information by extracting a CAN ID from the in-vehicle CAN data in units of frame and performing zero padding and configured to generate second feature information by extracting a CRC field from the in-vehicle CAN data in units of frame and performing the zero padding;
a learning unit configured to train a learning model by setting the first feature information and the second feature information as input data and labeling, as output data, whether the CAN data is attack data or normal data; and
a detector configured to detect whether the CAN data is normal data or attack data by extracting a CAN ID and a CRC field from the received in-vehicle CAN data when training of the learning model is completed and inputting the CAN ID and the CRC field to the learning model.

10. The intrusion detection system of claim 9, wherein
the CAN ID is composed of a maximum of 29 bits, and
the CRC field is composed of a maximum of 21 bits.

11. The intrusion detection system of claim 10, wherein
the controller is configured to generate the first feature information by receiving the CAN data in units of frame, extracting the CAN ID from the CAN data, and performing the zero padding to 29 bits when the CAN ID is less than 29 bits.

12. The intrusion detection system of claim 11, wherein
the controller is configured to generate the second feature information by extracting the CRC field from the CAN data received in units of frame and performing the zero padding to 21 bits when the CRC is less than 21 bits.

13. The intrusion detection system of claim 9, wherein
the learning model is based on a recurrent neural network (RNN).

14. The intrusion detection system of claim 13, wherein
the learning model is a long short-term memory (LSTM) neural network.

15. The intrusion detection system of claim 14, wherein
the learning unit is configured to train the learning model by inputting the first feature information composed of 29 bits and the second feature information composed of 21 bits, which are included in the same frame, to the LSTM neural network, combining, through a concatenation layer, the first feature information and the second feature information that pass through the LSTM neural network, causing the combined information to pass through a fully connected (FC) layer, and training the LSTM neural network by labeling, as output data, whether the CAN data of a corresponding frame is attack data or normal data.

16. The intrusion detection system of claim 9, wherein
the CAN data includes a controller area network with flexible data rate (CAN-FD) data.
